(19) United States
(12) Patent Application Publication
(10) Pub. No.: US 2023/0099620 A1
(43) Pub. Date: Mar. 30, 2023

(54) VALVE ASSEMBLY FOR RESIN TRANSFER MOLDING

(71) Applicant: NATIONAL RESEARCH COUNCIL OF CANADA, Ottawa (CA)

(72) Inventors: Paul Arthur TRUDEAU, Gatineau (CA); Simon BARIL-GOSSELIN, Longueuil (CA); Mathieu ST-GERMAIN, St-Marc-sur-Richelieu (CA)

(21) Appl. No.: 17/802,846

(22) PCT Filed: Feb. 26, 2021
(86) PCT No.: PCT/IB2021/051618

§ 371 Date: Aug. 26, 2022

Related U.S. Application Data
(60) Provisional application No. 62/982,489, filed on Feb. 27, 2020.

(51) Int. Cl. B29C 70/54; B29C 70/48

(52) U.S. Cl. CPC B29C 70/548; B29C 70/48

(57) ABSTRACT

A valve assembly for resin transfer molding is provided. The valve assembly includes an inlet positioned to receive a fluid. The valve assembly additionally includes a valve shaft positioned to receive the fluid from the inlet. The valve assembly further includes an outlet positioned to receive the fluid from the inlet. The valve assembly also includes an injection port positioned to receive the fluid from the valve shaft. The valve assembly also includes a piston configured to move coaxially within the valve shaft, such that the fluid is delivered from the inlet to the outlet when the piston is in a first position, and the fluid is delivered from the inlet to the injection port when the piston is in a second position.

### CROSS-REFERENCE TO RELATED APPLICATION

This application claims the benefit of U.S. provisional application No. 62/982,489 entitled “VALVE ASSEMBLY FOR RESIN TRANSFER MOLDING” and filed on Feb. 27, 2020, which is incorporated by reference herein.

### FIELD OF THE INVENTION

The present invention relates generally to injection molding, and more particularly, to a valve assembly for resin transfer molding.

### BACKGROUND OF THE INVENTION

Resin transfer molding (“RTM”) is a type of injection molding. Components of a resin, such as a thermoset resin and hardener, may be combined in a mix head and injected into a closed mold. After injection, the resin polymerizes into a rigid plastic. The process is used to produce fiber-reinforced plastic/polymer composites by placing a fiber preform inside the mold and saturating the preform with resin. The process may also be used to produce products with embedded objects such as form cores, as well as other objects of other structure.

There are several types of RTM. In Light RTM, a partial vacuum on one side of the fiber mat may draw the resin into the fiber preform for complete saturation. The resin is injected under relatively low heat and low pressure. In High Pressure-RTM (“HP-RTM”) on the other hand, the resin is injected into the mold at high pressures. The high injection pressure increases the flow rate resulting in shorter resin injection time and rapid and uncontrolled filling of the preform. Since the resin can be injected into the mold cavity in a shorter span of time, this process allows the use of resins with relatively high reactivity. In Compression RTM (“C-RTM”), the resin is injected into a partially closed mold and onto a dry preform. The resin flows over the preform, and then the resin is mechanically forced through the preform when the mold closes. Since the flow length is shorter, C-RTM has a fast injection time without the high pressures required by HP-RTM.

A challenge of RTM is that the resin may harden inside the injection system, clogging the machinery. When injecting thermoset resins during RTM, the metering system often needs to be cleaned after each shot to prevent clogging. In many cases, the injection lines and valves may need to be replaced after each shot. Pneumatically controlled valves are often used for light RTM which closes after the mold cavity is filled and is flushed with acetone and air. However, this valve is not suited to the high pressures or temperatures of HP-RTM or C-RTM. Polyurethane mix-heads are also used and are typically mechanically cleaned after each shot. However, these components are usually very large and expensive to replace and/or clean.

### SUMMARY OF THE INVENTION

According to a first aspect, the invention includes a valve assembly for resin transfer molding comprising:

an inlet positioned to receive a fluid,

a valve shaft positioned to receive the fluid from the inlet,

a piston configured to move coaxially within the shaft,

an outlet positioned to receive the fluid from the valve shaft, and

an injection port positioned to receive the fluid from the valve shaft.

The piston is moveable between a first position and a second position; wherein, when the piston is in the first position, the fluid is delivered from the inlet to the outlet and movement of the fluid to the injection port is impeded; and wherein, when the piston is in the second position, the fluid is delivered from the inlet to the injection port and movement of the fluid to the outlet is impeded.

The piston may include a channel positioned to communicate the inlet to the outlet when the piston is in the first position.

The channel may be disposed on an outer circumferential surface of the piston.

A coupling link may connect the piston to an actuator.

The coupling link may permit the piston to move pivotally around the universal joint.

The coupling link may impede axial rotation of the piston.

The actuator may be selected from a group consisting of a hydraulic actuator, a pneumatic actuator, an electric actuator, and a combination thereof.

The valve shaft may include an inner diameter and the piston may include an outer diameter, and the outer diameter may be about the same as the inner diameter of the valve shaft.

The piston may include a sleeve disposed on an outer circumferential surface of the piston, and the sleeve may be adapted to reduce wear to an inner circumferential surface of the valve shaft.

The piston may include a sleeve disposed on an outer circumferential surface of the piston, and the sleeve may be adapted to provide sealing between the valve shaft and the piston.

The valve shaft may include a lining disposed on an inner circumferential surface of the valve shaft, and the lining may be adapted to reduce wear to an outer circumferential surface of the piston.

The valve shaft may include a lining disposed on an inner circumferential surface of the valve shaft, and the lining may be adapted to provide sealing between the valve shaft and the piston.

According to a second aspect, the invention includes a valve assembly for resin transfer molding comprising:

an inlet positioned to receive a fluid;

a valve shaft positioned to receive the fluid from the inlet;

an outlet positioned to receive the fluid from the valve shaft;

a piston moveable between at least a first position and a second position within the valve shaft, wherein the piston includes a channel which is positioned to communicate the inlet to the outlet when the piston is in the first position; and

an injection port positioned to receive the fluid from the valve shaft;

wherein a channel is disposed on an outer circumferential surface of the piston; wherein the valve shaft includes an inner diameter and the piston includes an outer diameter, and wherein the outer diameter of the piston is about the same as the inner diameter of the valve shaft; wherein, when the piston is in the first position, fluid is delivered from the inlet to the outlet and movement of the fluid to the injection port is impeded; and wherein, when the piston is in the second position, fluid is delivered from the inlet to the injection port and movement of the fluid to the outlet is impeded.

A coupling link may connect the piston to an actuator, the coupling link may permit the piston to move pivotally around the universal joint, and the coupling link may impede axial rotation of the piston.

The actuator may be selected from a group consisting of a hydraulic actuator, a pneumatic actuator, an electric actuator, and a combination thereof.

The piston may include a sleeve disposed on the outer circumferential surface of the piston, the sleeve may be adapted to reduce wear to an inner circumferential surface of the valve shaft, and the sleeve may be further adapted to provide sealing between the valve shaft and the piston.

The valve shaft may include a lining disposed on an inner circumferential surface of the valve shaft, the lining may be adapted to reduce wear to the outer circumferential surface of the piston, and the lining may be further adapted to provide sealing between the valve shaft and the piston.

According to a third aspect, the invention includes a method of injection molding using a valve assembly, the method comprising:

moving a piston of the valve assembly into a first position;

with the piston in the first position, delivering a fluid from an inlet to an outlet;

moving the piston into a second position;

with the piston in the second position, delivering a thermoset resin from the inlet to an injection port; and

delivering the thermoset resin from the injection port to a mold cavity.

Delivering the fluid from the inlet to the outlet may be performed by recirculating the thermoset resin through the inlet and outlet.

Delivering the fluid from the inlet to the outlet may comprise delivering a solvent from the inlet to the outlet.

### BRIEF DESCRIPTION OF THE DRAWINGS

Reference will now be made, by way of example only, to the accompanying drawings in which:

FIG. 1a is a perspective view of a valve assembly with a piston in a first position.

FIG. 1b is a perspective view of the valve assembly of FIG. 1a with the piston in a second position.

FIG. 2 is a cut-away view of another valve assembly.

FIG. 3 is a cross-sectional view of another valve assembly.

FIG. 4 is an exploded view of the piston and coupling link of FIG. 3.

FIG. 5 is a schematic diagram of a method of using a valve assembly with resin recirculation.

FIG. 6 is a schematic diagram of a method of using a valve assembly with solvent flushing.

### DETAILED DESCRIPTION OF THE EMBODIMENTS

A valve assembly and a method of using a valve assembly for injection molding are provided. In one aspect of the invention, the valve assembly is a reusable, low-maintenance valve for RTM. A piston of the valve may be actuated to deliver resin to a mold or to divert resin or other fluid away from the mold. Liquid resin may be recirculated through the valve, bypassing the mold and inhibiting gelation of the resin within the injection molding system. In another aspect of the invention, a cleaning solution may pass through the valve assembly, bypassing the mold and clearing resin from the valve and lines of the system. In a further aspect of the invention, the valve assembly is powered by an actuator and suitable for the high pressure of C-RTM and HP-RTM.

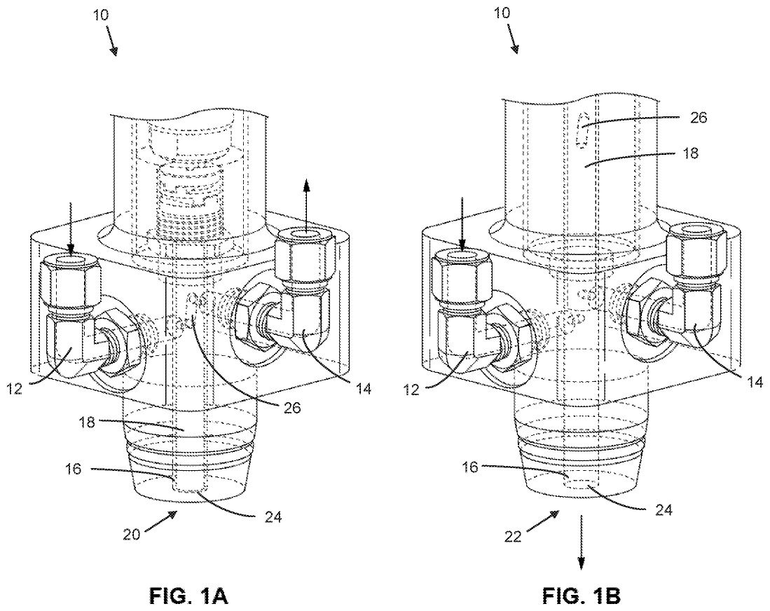

Referring to FIGS. 1a and 1b, a valve assembly 10 for injection molding is generally shown. In the present embodiment, the valve assembly 10 includes an inlet 12 for receiving a fluid and an outlet 14 for fluid to exit the valve 10. A valve shaft 16 connects the inlet 12 to the outlet 14. A piston 18 is moveable coaxially within the valve shaft 16 between a first position 20 (see FIG. 1a, where the piston 18 is shown lowered) and a second position 22 (see FIG. 1B, where the piston 18 is shown raised). The valve shaft 16 connects to an injection port 24. As shown in FIG. 1a, when the piston 18 is in the first position 20, the fluid can be delivered from the inlet 12 to the outlet 14 of the valve assembly 10, and movement of the fluid to the injection port 24 is impeded by the presence of the piston 18 in the shaft 16. As shown in FIG. 1b, when the piston 18 is in the second position 22, the fluid can be delivered from the inlet 12 to the injection port 24 through the valve shaft 16, and movement of the fluid to the outlet 14 is impeded. The fluid may include resin, hardener, thermoset resin, thermoplastic resin, solvent, cleaning solution, or water.

The piston 18 may include a channel 26 that is positioned to communicate the inlet 12 to the outlet 14 when the piston 18 is in the first position 20. The channel 26 may be an opening, duct, pipe, tube, groove, or other conduit suitable for conveying materials, such as fluids.

The inlet 12 may be an opening, duct, pipe, tube, channel or other conduit suitable for conveying materials.

The valve shaft 16 may be an opening, duct, pipe, tube, channel, hollow cylinder, or other conduit suitable for accommodating the piston 18 and conveying material to a mold cavity.

The piston 18 may be a pin, stem, rod, bar, cylinder, or similar structure that may be slidably disposed within the shaft 16.

The outlet 14 may be an opening, duct, pipe, tube, channel or other conduit suitable for conveying materials. As shown in FIGS. 1a and 1b, the outlet 14 may meet the valve shaft 16 at a point further from the injection port 24 than the point where the inlet 12 joins the valve shaft 16, such that the piston 18, when in the second position 22, blocks the outlet 14 but does not block the inlet 12. That is, the outlet 14 may be located above the inlet in the orientation shown, where the injection port 24 is at the lower extent of the valve 10. The outlet 14 may be positioned 90 degrees from the inlet 12, with respect to the longitudinal axis of the valve assembly 10, to allow for a compact valve design, as shown. However, the positioning of the outlet 14 relative to the inlet 12 is not particularly limited.

The injection port 24 may be an opening, duct, pipe, tube, channel or other conduit suitable for conveying materials.

The piston 18 may move between at least a lowered position (see FIG. 1a) and a raised position (see FIG. 1B). When in the lowered position, the piston 18 may permit the fluid to move from the inlet 12 to the outlet 14, via the channel 26, while covering at least part of the injection port 24. When in the second position 22, the piston 18 may cover at least part of the outlet 14 while permitting the fluid to move from the inlet 12 to the injection port 24.

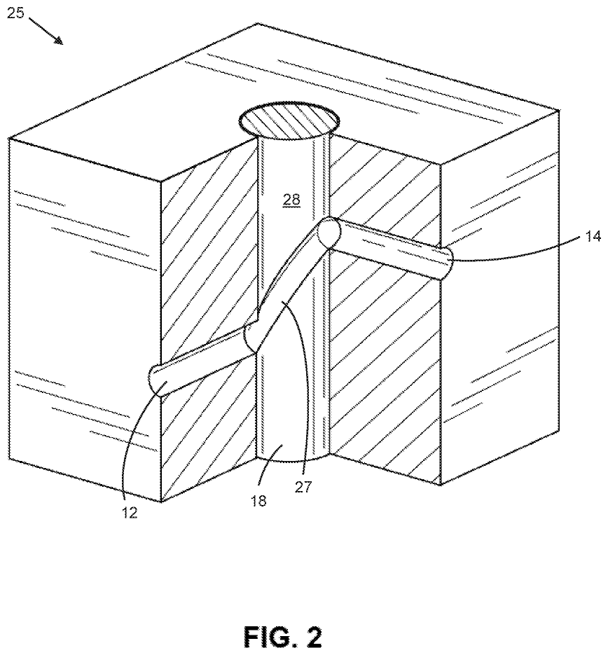

Referring to FIG. 2, an embodiment, similar to that of FIGS. 1a and 1b, is provided. The description of FIGS. 1a and 1b may be referenced for details not repeated here, with like reference numerals and terminology denoting like components.

A cut-away of a valve assembly is generally shown at 25. A channel 27 is disposed on an outer circumferential surface of the piston 28. The channel 27 may be aligned vertically or helically along the outer circumferential surface of the piston 18. As can be seen, the channel 27 communicates the inlet 12 to the outlet 14 in this position. When the piston 18 is translated within the shaft (e.g., upwards in the figure), the channel 27 becomes misaligned with the inlet 12 and the outlet 14 and this impedes or blocks fluid communication.

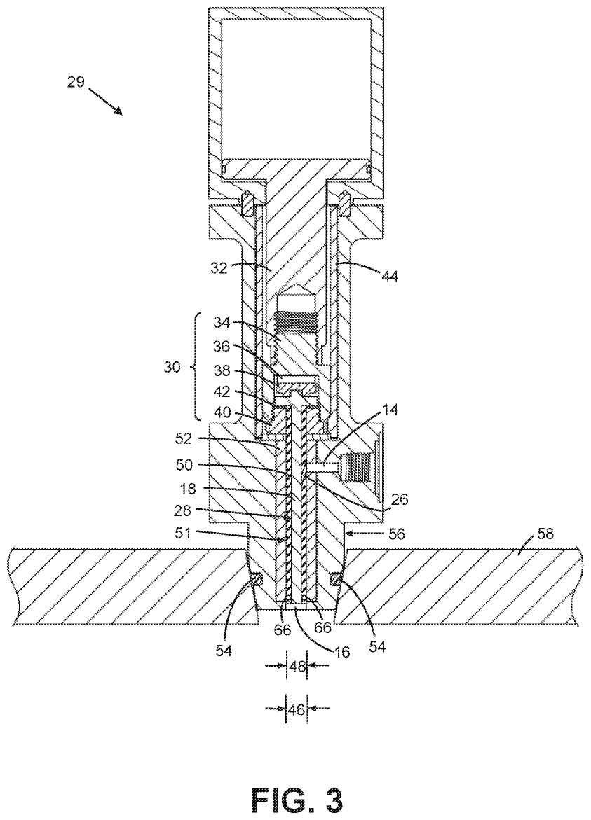

Referring to FIG. 3, an embodiment similar to that of FIGS. 1a, 1b, and 2 is provided. The description of FIGS. 1a, 1b, and 2 may be referenced for details not repeated here, with like reference numerals and terminology denoting like components.

The valve assembly is generally shown at 29. In the present embodiment, a coupling link 30 may connect the piston 18 to an actuator 32. The coupling link 30 may be a joint, fastener, connector, or other means of attachment. The coupling link 30 may comprise one or multiple components. In the embodiment of FIG. 3, the coupling link 30 includes a securing part 34, a joining element 36, a connector 38, a fastener 40, and a washer 42. The fastener 40 connects the piston 18 to the securing part 34 of the coupling link 30. The connector 38 connects the piston 18 to the joining element 36. The connector 38 has orthogonal grooves on opposite sides. The piston 18 and the joining element 36 each has a complementary ridge that fits a groove on the connector to allow two-dimensional pivoting but prevent axial rotation. The joining element 36 connectors the connector to the securing part 34.

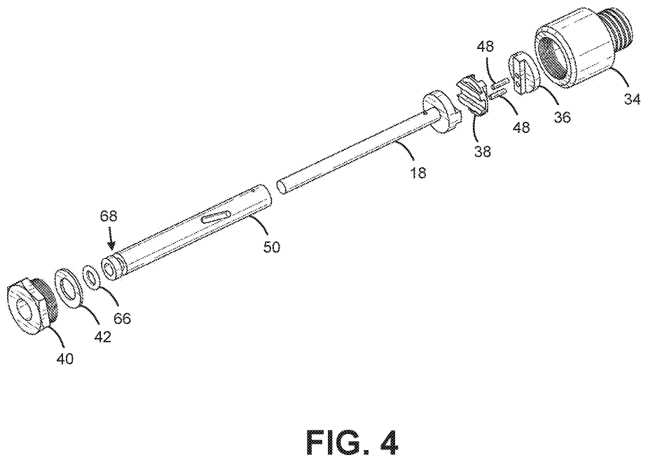

The securing part 34 connects the coupling link 30 to the actuator 32. The coupling link 30 may be positioned within a housing 44. This embodiment is also illustrated in FIG. 4 as an exploded view of the piston 18, a piston sleeve, and the coupling link 30. The exploded view additionally shows two pins 48 that attach the connector 38 to the joining element 36. The coupling link 30 shown in FIG. 3 and FIG. 4 is merely illustrative of a coupling link that may be used, and other suitable means of attachment may connect the piston 18 to the actuator 32.

The actuator 32 may be a hydraulic actuator. The actuator 32 may drive the piston 18 from the first position 20 to the second position 22 and from the second position 22 to the first position 20. The actuator 32 may be a hydraulic actuator, electric actuator, pneumatic actuator, or a combination of such. Example hydraulic actuators include a hydraulic cylinder, hydraulic motor, hydraulic pump, or hydraulic piston. One advantage of the actuator 32 being a hydraulic actuator is that it can facilitate injection of resin at pressures of 100-1000 psi, for example.

The coupling link 30 may permit the piston 18 to pivot slightly around the coupling link 30. Pivoting in this sense means non-axial rotation. Axial rotation is prevented, as such rotation could cause misalignment between the inlet and the channel. This may allow for strict tolerances between the valve shaft 16 and the piston 18 to avoid unwanted friction and wearing between the two components. Allowing the piston 18 to pivot may prevent or lessen frictional forces between the valve shaft and the piston 18. Allowing the piston 18 to pivot may prevent or lessen wearing to the valve shaft 16 or the piston 18.

The coupling link 30 may impede axial rotation of the piston 18. It is to be appreciated that rotation of the piston 18 may result in misalignment between the channel 27 and the inlet 12 and outlet 14 when the piston 18 is in the first position 20. A coupling link 30 that restrain the rotation of the piston 18 may ensure continued alignment of the channel 27 with the inlet 12 and outlet 14. For example, the actuator 32 may include structure that prevents rotation of its moveable component, and the coupling link 30 may constrain the piston 18 to have a fixed orientation with respect to the moveable component of the actuator 32. That is, the coupling link 30 may extend the anti-rotation function of the actuator 32 to the piston 18.

In the embodiment of FIG. 3, the valve shaft 16 has an inner diameter 46 and the piston 18 has an outer diameter 48. For example, the outer diameter of the piston 18 may be about 8 mm (0.315 inches), 11 mm (0.433 inches), or similar size, but the piston 18 is not particularly limited in diameter. A suitable range of diameters is contemplated to be about 6 mm (0.236 inches) to about 20 mm (0.787 inches), but this is not particularly limiting. However, it should be recognized that smaller diameters may increase the difficulty of forming the channel 27 and providing adequate sealing.

The inner diameter of the valve shaft 16 is about the same as the inner diameter of the piston 18. That is, the diameters of the valve shaft 16 and piston 18 may be selected to allow a relative sliding motion with reduced or minimized interference and reduced or minimized leakage of material, such as resin or solvent. For example, the difference between the inner diameter of the valve shaft 16 and the outer diameter of the piston 18 may be around about ±0.025-0.050 mm (±0.001-0.002 inches). One advantage of the tight tolerance is that it may provide sealing between the piston 18 and the valve shaft 16. The sealing may impede liquid from moving through the injection port when the piston 18 is in the first position 20. The sealing may further impede liquid from moving through the outlet 14 when the piston 18 is in the second position 22.

In the embodiment of FIG. 3, the piston 18 has a sleeve 50 disposed on an outer circumferential surface of the piston 28. The sleeve may be adapted to reduce wear to an inner circumferential surface of the valve shaft 51. The degree of wear to valve shaft 16 may depend on the material of the sleeve 50. For example, the sleeve 50 may be bronze. The channel 27 may pass through the sleeve 50 or may be a groove disposed on the sleeve 50. Alternatively, the channel 27 may pass through both the sleeve 50 and the piston 18.

The sleeve 50 is further adapted to provide sealing between the valve shaft 16 and the piston 18. Sealing may depend on the material of the sleeve 50 and the temperature of the valve assembly 29. To further facilitate sealing between the valve shaft 16 and the piston 18, an o-ring 66 may be included in the piston 18. A groove 68 may be disposed on the outer circumferential surface of the piston 28 to accommodate the o-ring.

In the embodiment of FIG. 3, the valve shaft 16 has a lining 52 on the inner circumferential surface of the valve shaft 51. The lining 52 may be adapted to reduce wear to the outer circumferential surface of the piston 28. Wear to the piston 18 may depend on the material of the lining 52. For example, the lining may be bronze. The inlet 12 may pass through the lining 52 to communicate with the channel 27 or the valve shaft 16. Similarly, the outlet 14 may pass through the lining 52 to communicate with the channel 27.

The lining 52 is further adapted to provide sealing between the valve shaft 16 and the piston 18. Sealing may depend on the material of the lining 52 and the temperature of the valve assembly 29.

The valve assembly 29 may include an o-ring 54. The o-ring 54 may be disposed on an outer surface of the valve assembly 56. The o-ring may provide sealing between the valve assembly 29 and the mold 58.

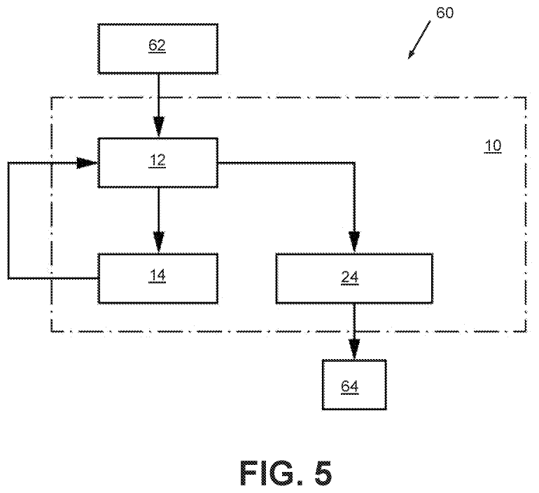

Referring to FIG. 5, a schematic diagram is shown at 60 demonstrating a method of use of a valve assembly 10 or 29. A thermoset resin 62 may be recirculated through the valve assembly 29 and may be injected into a mold cavity 64. A thermoset resin 62 is delivered to the inlet 12 of valve assembly 29. When the piston 18 is in a first position, the thermoset resin 62 is delivered to an outlet 14 and recirculated back to the inlet 12. The piston 18 may be moved from a first position to a second position. The thermoset resin 62 is then delivered to an injection port 24 and injected into the mold cavity 64. These steps need not be performed in the exact sequence presented and could be performed in parallel rather than in sequence, or in a different sequence altogether.

The temperature of the thermoset resin 62 may be a temperature below the curing temperature of the thermoset resin 62. One advantage of the embodiment illustrated in FIG. 5 is that, before and after a mold cavity 64 is injected with thermoset resin 62, the thermoset resin 62 may circulate through the valve assembly 29 and the injection system until the next injection or until the valve assembly 29 and injection system are cleaned. The movement of the thermoset resin 62 lessens gelation and clogging within the machinery.

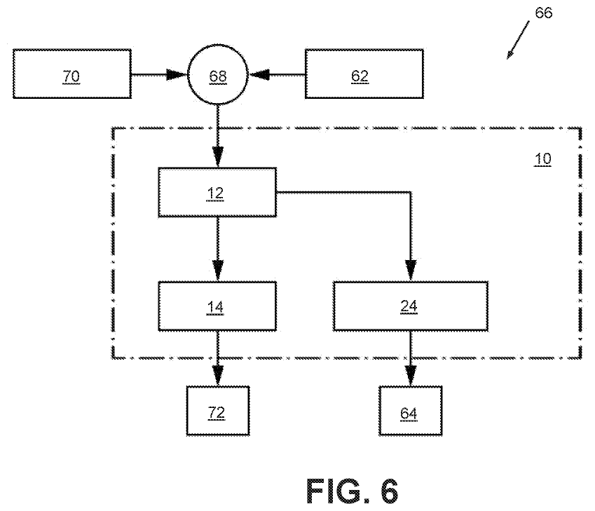

Referring to FIG. 6, a schematic is shown at 66 demonstrating a method of use of a valve assembly 10 or 29. A thermoset resin 62 may be delivered to an inlet 12 of the valve assembly 10 or 29 via a material delivery valve 68. With the piston 18 of the valve assembly 10, 29 in a second position, the thermoset resin 62 is delivered from the inlet 12 to the injection port 24. The thermoset resin 62 is injected from the injection port 24 into a mold cavity 64. Subsequently, a solvent 70 may be delivered to the inlet 12 via the material delivery valve 68. With the piston in a first position, the solvent 70 is delivered from the inlet 12 to the outlet 14. The solvent 70 is delivered from the outlet 14 to a disposal vessel 72. The solvent may be a cleaner, rinsing solution, water, release agent, or other fluid.

One advantage of the embodiment illustrated in FIG. 6 is that, after a mold cavity 64 is injected with thermoset resin 62, the valve system and injection system may be flushed with a solvent to remove residue and prevent clogging.

It should now be apparent that the various embodiments of the valve assembly, and methods thereof, illustrated and described herein are suitable for use in RTM and particularly high-pressure and high-temperature RTM. The valve assembly discussed herein allows a resin to be circulated through the valve assembly to prevent or lessen gelation of a liquid resin within an injection molding system. In another embodiment of the valve assembly described herein, a solution may be flushed through the valve assembly to clean the injection molding system without passing through the injection port. An advantage of the valve assembly described herein is that the valve assembly may be re-used after injection. A further advantage of the valve assembly is that the valve assembly may be maintained and cleaned at low-cost.

We claim:

1. A valve assembly for resin transfer molding comprising:
an inlet positioned to receive a fluid;
a valve shaft positioned to receive the fluid from the inlet;
a piston configured to move coaxially within the valve shaft;
an outlet positioned to receive the fluid from the inlet; and
an injection port positioned to receive the fluid from the valve shaft;
wherein the piston is moveable between at least a first position and a second position;
wherein, when the piston is in the first position, the fluid is delivered from the inlet to the outlet and movement of the fluid to the injection port is impeded; and
wherein, when the piston is in the second position, the fluid is delivered from the inlet to the injection port and movement of the fluid to the outlet is impeded.

2. The valve assembly of claim 1 wherein the piston includes a channel positioned to communicate the inlet to the outlet when the piston is in the first position.

3. The valve assembly of claim 2, wherein the channel is disposed on an outer circumferential surface of the piston.

4. The valve assembly of claim 1, further comprising a coupling link that connects the piston to an actuator.

5. The valve assembly of claim 4 wherein the coupling link permits the piston to move pivotally around the coupling link.

6. The valve assembly of claim 4, wherein the coupling link impedes axial rotation of the piston.

7. (canceled)

8. The valve assembly of claim 1, wherein the valve shaft includes an inner diameter and the piston includes an outer diameter, and wherein the outer diameter of the piston is about the same as the inner diameter of the valve shaft.

9. The valve assembly of claim 1,
wherein the piston includes a sleeve disposed on an outer circumferential surface of the piston; and
wherein the sleeve is adapted to reduce wear to an inner circumferential surface of the valve shaft.

10. The valve assembly of claim 1,
wherein the piston includes a sleeve disposed on an outer circumferential surface of the piston; and
wherein the sleeve is adapted to provide sealing between the valve shaft and the piston.

11. The valve assembly of claim 1,
wherein the valve shaft includes a lining disposed on an inner circumferential surface of the valve shaft; and
wherein the lining is adapted to: reduce wear to an outer circumferential surface of the piston, provide sealing between the valve shaft and the piston, or reduce wear to an outer circumferential surface of the piston and provide sealing between the valve shaft and the piston.

12. (canceled)

13. The valve assembly of claim 1 wherein, when the piston is in the second position, the fluid is selected from the group consisting of resin, hardener, thermoset resin, thermoplastic resin, solvent, cleaning solution, and water.

14. The valve assembly of claim 1, wherein, when the piston is in the first position, the fluid is selected from the group consisting of cleaner, rinsing solution, water, and release agent.

15. A valve assembly for resin transfer molding comprising:
an inlet positioned to receive a fluid;
a valve shaft positioned to receive the fluid from the inlet;
an outlet positioned to receive the fluid from the valve shaft;
a piston moveable between at least a first position and a second position within the valve shaft, wherein the piston includes a channel which is positioned to communicate the inlet to the outlet when the piston is in the first position; and
an injection port positioned to receive the fluid from the valve shaft;
wherein a channel is disposed on an outer circumferential surface of the piston;
wherein the valve shaft includes an inner diameter and the piston includes an outer diameter, and wherein the outer diameter of the piston is about the same as the inner diameter of the valve shaft;
wherein, when the piston is in the first position, the fluid is delivered from the inlet to the outlet and movement of the fluid to the injection port is impeded; and
wherein, when the piston is in the second position, the fluid is delivered from the inlet to the injection port and movement of the fluid to the outlet is impeded.

16. The valve assembly of claim 15, further comprising a coupling link that connects the piston to an actuator; wherein the coupling link permits the piston to move pivotally around the coupling link; and wherein the coupling link impedes axial rotation of the piston.

17. (canceled)

18. The valve assembly of claim 15,
wherein the piston includes a sleeve disposed on the outer circumferential surface of the piston;
wherein the sleeve is adapted to reduce wear to an inner circumferential surface of the valve shaft; and
wherein the sleeve is further adapted to provide sealing between the valve shaft and the piston.

19. The valve assembly of claim 15,
wherein the valve shaft includes a lining disposed on an inner circumferential surface of the valve shaft;
wherein the lining is adapted to reduce wear to the outer circumferential surface of the piston; and
wherein the lining is further is adapted to provide sealing between the valve shaft and the piston.

20. A method of injection molding using a valve assembly, the method comprising:
moving a piston of the valve assembly into a first position;
with the piston in the first position, delivering a fluid from an inlet to an outlet;
moving the piston into a second position;
with the piston in the second position, delivering the fluid from the inlet to an injection port; and
delivering the fluid from the injection port to a mold cavity.

21. The method of claim 20, wherein delivering the fluid from the inlet to the outlet is performed by recirculating a thermoset resin through the inlet and outlet.

22. The method of claim 20, wherein delivering the fluid from the inlet to the outlet comprises delivering a fluid selected from the group consisting of solvent, cleaner, rinsing solution, water, and release agent from the inlet to the outlet.

23. The method of claim 20 wherein delivering the fluid from the inlet to the injection port or from the injection port to the mold cavity comprises delivering a fluid selected from the group consisting of resin, hardener, thermoset resin, thermoplastic resin, solvent, cleaning solution, and water from the inlet to the injection port or from the injection port to the mold cavity.

24. (canceled)
